(19) United States
(12) Patent Application Publication
(10) Pub. No.: US 2023/0420903 A1
(43) Pub. Date: Dec. 28, 2023

(54) CABLE PROCESSING DEVICE AND METHOD FOR SETTING UP A CABLE PROCESSING DEVICE

(71) Applicant: Komax Holding AG, Dierikon (CH)

(72) Inventors: Stefan Viviroli, Horw (CH); Chris Schnellmann, Sins (CH)

(21) Appl. No.: 18/337,072

(22) Filed: Jun. 19, 2023

(30) Foreign Application Priority Data
Jun. 23, 2022 (EP) 22180740.7

(51) Int. Cl. H01R 43/052

(52) U.S. Cl. CPC H01R 43/052

(57) ABSTRACT

A cable processing device for assembling cables includes processing stations, a feed unit having a cable gripper, and a machine controller. When the feed unit is in a setup mode, the cable gripper can be moved manually to one of the processing stations into a desired position. After the desired position has been established, this position is stored in the machine controller so that, thereafter, the cable gripper can be brought automatically into this position in the normal operating mode of the cable processing device. In order to move the cable gripper in the normal operating mode, the feed unit has servo or stepper motors equipped with encoders. Furthermore, the cable processing device has a protective hood. When the protective hood is in the open position and cable processing device is in the setup mode, the machine controller de-energizes the actuators for operating the processing stations and the feed unit.

### FIELD

This invention relates to a cable processing device for assembling cables. Furthermore, the invention relates to a method for setting up such a cable processing device.

### BACKGROUND

When assembling cables, cable ends of the cables are crimped or processed in another way. “Crimping” is understood to mean the production of a non-detachable electrical and mechanical connection (crimp connection) by plastic deformation between a conductor and a crimp contact. For a higher requirement with regard to tightness, the stripped cable ends can be equipped with sleeves in sleeve stations before the crimping.

A generic, comparable cable processing device has become known from EP 1 447 888 A1. EP 1 447 888 A1 shows a cable processing device with a stripping unit and two crimping stations with crimping presses. The apparatus also has a cable feed designed as a tape drive for moving the cable along a longitudinal machine axis. The stripping unit for cutting to length and stripping the cable ends is arranged on the longitudinal axis of the machine. Since the two crimping stations are located alongside the longitudinal machine axis, the cable needs to be guided from pivot units to the respective crimping presses for the crimping stations by means of pivot arms provided with grippers, which is why this kind of cable processing device is also known and familiar to the person skilled in the art referred to as “pivot machines”. The feed unit comprising the cable gripper is in this case a so-called “pivot unit”. In the first crimping station, the leading cable end is equipped with crimp contacts, and with the second crimping station, the trailing cable end is equipped with crimp contacts. The cable processing device can be monitored and controlled via a machine controller and a central operating unit.

The known cable processing devices have proven successful with respect to production operation. Process parameters can be monitored and adapted comparatively easily with the machine controller and the central operating unit. However, before mass production of assembled cables, the individual processing stations must be set up. Depending on the cables to be processed, crimp contacts and/or sleeves, the machine settings must be adapted to the different requirements. This setup process is, in particular, especially important with respect to the crimping stations, since the cable ends to be processed must be positioned as precisely as possible in the crimping tool on a crimping press for the crimping station. Setup may also be necessary after the crimping tool has been changed.

Cable processing devices in which the setup process is performed from a central control console for the machine are known. For example, for crimping, the user or machine operator operates the control console in single-step operation for positioning the cable gripper relative to the crimping station. In doing so, the user must often move back and forth between the control console and the processing stations in order to visually check the progress. EP 3 024 099 A1 discloses a cable processing device in which individual processing stations are provided with operating units. By means of these operating units, the respective processing stations can be set up locally. However, for personal safety, the cable processing devices has a protective hood, wherein the setup must be carried out when the protective hood is open.

### SUMMARY

It is therefore a function of the present invention to avoid the disadvantages of the prior art and, in particular, to create a cable processing device that is easy and safe to operate with regard to setting up the cable processing device.

This object is achieved according to the invention with a cable processing device having the features described herein. The cable processing device serves to assemble cables and comprises one or more processing stations for processing the cable ends of the cables. Examples of processing stations include stripping stations, sleeve stations and crimping stations. Furthermore, the cable processing device has a feed unit, comprising a cable gripper, for feeding a cable end of the cable to at least one of the processing stations, and a machine controller for controlling the cable processing device. Whereby the feed unit is set up in such a way that in a setup mode, the cable gripper can be moved manually at least to one of the processing stations, for example to a crimping station, into a desired position and the machine controller is designed in such a way that, after the desired position has been established manually, this position or an associated control variable can be or is stored in the machine controller so that, thereafter, the cable gripper can be or is brought or moved automatically into this position in the normal operating mode, and an advantageous cable processing device is created with regard to the setup. The cable processing device can be set up efficiently and, nevertheless, safely. Incorrect machine settings can practically be ruled out thanks to the intuitive user guidance for setting up. The setup of the cable processing device can also be carried out easily and reliably by persons with a low level of training or after a short learning time. In the present document, “setup” is understood to mean the initial setting of parameters for a respective processing station for processing cable ends of cables before starting the production process for mass production of assembled cable ends. In other words, this concerns newly setting, correcting or changing parameters before the production process is started. During setup, it is possible, inter alia, to apply a setting ensuring that, in a normal operating mode assigned to the production process, the cable gripper moves into the correct position, for example to the crimping station or to another processing station. In the following, this aspect of the setup, i.e., the positioning of the cable gripper, is in the foreground. The setup mode is the mode in which a setup process is carried out in which positions for the cable gripper with respect to a processing station can be changed and set. If the cable processing device comprises several processing stations and, in particular, several processing stations of the same type (e.g., crimping stations), several setup processes are generally to be carried out accordingly.

In the example of the crimping station, the position into which the cable gripper has to be moved manually corresponds to a starting position of the cable gripper at the beginning of the actual crimping process in the crimping station (or another processing process in a processing station). For example, the cable end held by the cable gripper is in the mentioned position in a crimping press of the crimping station and preferably between the two crimping tools (anvil and crimping die). The cable end is now in the desired or correct position, from which (hence the starting position) the crimping tools are moved toward one another and closed, as a result of which the crimp contact is applied to the cable end.

For the manual movement of the cable gripper into the desired position, the feed unit for the cable processing device can preferably be designed in such a way that it can be operated one-handedly by a person. The setup process is preferably carried out using a cable gripper holding a cable. In this way, the position of the cable gripper and thus the position of the cable end held by the cable gripper can be recognized by the user, whether the position reached by the manual movement corresponds to the desired or correct position. As soon as this is the case, the user can release the cable gripper and the hand can be removed from the danger zone.

For manually moving the cable gripper, the relevant person grasps the cable gripper or another region of the feed unit with one hand or possibly also with two hands. If the feed unit has a front side, which is provided, for example, by a gripper head with gripper jaws, it may be advantageous if the person holds the feed unit on the front side at least in a final phase of the manual movement, whereby precise positioning is facilitated. However, the feed unit may also have other regions that can be grasped for manual movement of the cable gripper. These back or rear-side regions can be grasped in a first movement phase for establishing the desired position and held for manual movement.

In one embodiment, to move the cable gripper in the normal operating mode, the feed unit for the cable processing device can have servo or stepper motors equipped with encoders, by means of which motors the cable grippers can be moved at least to one of the processing stations. The encoders are connected to the machine controller and the machine controller is configured in such a way that the position of the cable gripper after the manual movement in the setup mode can be or is ascertained and stored by means of the encoders.

From a safety point of view, it may be advantageous if the cable processing device has a protective hood that can be moved between a closed position and an open position. In the closed position, the protective hood covers the at least one processing station and the feed unit with the cable gripper; in the open position, the protective hood creates a free space via which the at least one processing station and the feed unit are accessible for manual interactions for moving the cable gripper. In this open position, the cable processing device can be in the setup mode. The machine controller can be designed in such a way that, when the protective hood is in the open position and thus in the setup mode, the at least one processing station, preferably all critical and particularly preferably all processing stations for the cable processing device and the feed unit are deactivated and do not allow any processing process or other automatic movements. Injuries to the person's hand by moving parts can thus be ruled out. A further advantage of this arrangement is that further persons could also work safely on the cable processing device when the protective hood is open.

The machine controller can be designed in such a way that, when the protective hood is in the open position and thus in the setup mode, the machine controller de-energizes the electromotive actuators (e.g., servo or stepper motors) for operating the at least one processing station and/or the feed unit. Thus, the cable gripper can be safely moved manually into the desired position. If servo or stepper motors are present as actuators for operating the feed unit and, where applicable, individual or all processing stations, these actuators can be de-energized, for example, when the open position is established or in some other way, so that even in the case of unintentional or erroneous actuation of knobs or switches, it is ensured that no automatic movements of parts in the cable processing device, and in particular the relevant components of the cable processing device, which are to be set up at that moment, can take place and endanger the user. Through this de-energizing, the servo or stepper motors for moving the cable gripper can advantageously be put into a state in which the servo or stepper motors are inactive while the encoders, however, still function as before, and after the de-energized state has ended, the encoders can report the position data to the machine controller or can be retrieved by the latter.

The machine controller can furthermore be configured in such a way that the feed unit with the cable gripper and the processing station for the cable processing device to be set up can be put into a test mode. A test mode can be provided in which a single processing step (e.g., crimping of a cable end) is carried out for test purposes when the protective hood is closed. In the test mode, the movements of the participating components for the cable processing device preferably take place at a reduced speed or at a creep speed, e.g., half the speed. In the test mode, only the respective processing step is preferably carried out. The test mode allows simple observation of the processing step. After the processing step has been carried out for test purposes, the protection hood can be opened again. When the protective hood is in the open position and setup mode is thus established, the cable gripper can again be moved manually, but now into an observation position toward the user so that the cable end is in the vicinity of the user and can be easily seen by the user, so how the previously performed test has taken place can be checked. If the visual check has a positive result, the setup process is substantially completed at least with respect to the respective processing station. If the result is negative, i.e., when the visual check of the cable end results in a qualitatively insufficient result, the above-described setup process must be repeated.

It may be advantageous if the cable processing device comprises an operating unit with a hood button for operating the protective hood, wherein the hood button is connected to the machine controller in such a way that, during or after actuation of the hood button for establishing the open position of the protective hood, the setup mode can be automatically established. By means of the hood button, the cable processing device can be put into the setup mode in a simple manner. Alternatively, a separate input means, for example, a special button or switch provided for this purpose, which can be used to establish the setup mode, would also be conceivable.

The hood button for operating the protective hood can be a common button both for opening and closing, depending on the position in which the protective hood is at that moment, i.e., when the protective hood is in the closed position, the protective hood is brought into the open position after actuation of the hood button; and vice versa, when the protective hood is in the open position, the protective hood is brought into the closed position after actuation of the hood button. A special button is also conceivable by means of which the protective hood can only be transferred into the open position (“open-hood button”). The hood button can also be designed and integrated into the machine controller in such a way that it can be used to communicate, to the machine controller, the desire to open or close the protective hood.

The cable processing device can comprise an operating unit with a hood button for operating the protective hood, wherein the hood button is connected to the machine controller in such a way that, during or after actuation of the hood button, the protective hood can automatically be set to the closed position. This hood button is preferably the same button as the aforementioned hood button by means of which, during or after actuation of the hood button, the open position of the protective hood can be automatically established and the cable processing device can advantageously be put into the setup mode. In addition to the hood button, the operating unit can have a further button, which can be used to confirm that the protective hood is to be brought from the open position into the closed position. For better understanding, this further button is also referred to below as the “close-hood button” for the sake of simplicity. An actuation of the hood button can thus only indirectly, i.e., in combination with the aforementioned close-hood button, trigger an automatic movement of the protective hood from the open position into the closed position, which further increases the safety for the user.

Particularly preferably, the hood button and the button for confirming the hood closing process (close-hood button) are connected to the machine controller and the machine controller is configured in such a way that the protective hood can be brought from the open position into the closed position only if both buttons are pressed simultaneously. Preferably, the hood button and the button for confirming the hood closing process are in this case designed for two-handed operation and, for this purpose, are spaced apart from one another by at least 27 cm, for example. This arrangement can ensure that neither of the user's hands can remain in the danger zone when the protective hood is closed. Locally separating the two buttons ensures that one-handed operation is prevented with regard to the triggering of the closing process for the protective hood.

In a preferred embodiment, the cable processing device has an operating unit with a save button for storing the position of the cable gripper reached after the manual movement. The save button can be designed as a ductile button; a virtual button for a touch-sensitive control panel is also conceivable. Of course, for storing, other input means could also be provided by means of which the command for storing the position of the cable gripper can be communicated to the machine controller. For example, the operating unit for the cable processing device can have a hood button and, where applicable, additionally or alternatively a close-hood button, and that preferably simultaneous actuation of the close-hood button confirms that the respective setup process, in which the desired or correct position of the cable gripper is being defined, is completed and that the current position of the cable gripper is stored.

This save button can be arranged in the cable processing device and preferably outside the protective hood in such a way that the user can hold the feed unit with the cable gripper with one hand and can actuate the save button with the other hand in order to store the current position of the cable gripper.

The above-mentioned save button can preferably be assigned to the same operating unit that comprises the hood button and, where applicable, the button for confirming the hood closing process as well as, where applicable, further buttons.

The cable processing device can comprise several operating units each comprising a save button. Several operating units can ensure that several processing stations for the cable processing device can be easily set up. Each of the operating units can comprise a save button, a hood button and, where applicable, a button for confirming the hood closing process.

For example, the cable processing device can comprise two groups of processing stations, wherein a first group is assigned to a leading cable end and a second group is assigned to a trailing cable end of the cable, wherein at least one operating unit is assigned to each of the two groups. It can have two operating units which are arranged on opposite sides of the cable processing device with respect to a longitudinal machine axis.

For example, the cable processing device can comprise a crimping station as a processing station to which the cable gripper can be moved manually in the setup mode. The feed unit with the cable gripper can be designed, for example, as a pivot unit.

A further aspect of the invention relates to a method for setting up a cable processing device for assembling cables with at least one processing station and a feed unit, comprising a cable gripper, for feeding a cable end of the cable to at least one processing station and, in particular, to the cable processing device described above. The method comprises the following steps: First, the cable processing device is put into a setup mode, in which setup mode the feed unit and the at least one processing station are preferably deactivated and do not allow any processing process. Thereafter, the user can grasp the feed unit with one hand. The user manually moves the feed unit with the cable gripper until the cable gripper reaches a desired position in the processing station. The position of the cable gripper is then preferably stored in a machine controller, wherein the stored position is used by the machine controller for a normal operating mode in which the cable gripper is automatically moved to the processing station into the stored position. The novel method for setting up the cable processing device takes place according to an advantageous teach-in procedure, which can be carried out easily and intuitively.

After the position of the cable gripper has been stored, a single processing process with respect to the respective processing station can be carried out for test purposes and the cable end of the cable processed for test purposes in this way is visually checked in that the feed unit with the cable gripper is moved toward the user manually, i.e., by grasping it with the hand and moving (pulling, pushing, pivoting, lowering) it. The last-mentioned manual movement can advantageously also be performed in a mode in which the feed unit and the at least one processing station are deactivated and do not allow any processing process.

When the cable processing device comprises several processing stations, the above setup processes can be carried out analogously at one or more further processing stations.

When a protective hood covering the at least one processing station and the feed unit with the cable gripper is opened, the cable processing device is preferably put into the setup mode or into a mode in which the feed unit and the at least one processing station are deactivated and do not allow any processing process. In this way, accidents involving persons can practically be ruled out.

### DESCRIPTION OF THE DRAWINGS

Further individual features and advantages of the invention can be derived from the following description of embodiments and from the drawings. In the drawings:

FIG. 1: a plan view of a cable processing device,

FIG. 2: a perspective representation of a feed unit for the cable processing device in FIG. 1,

FIG. 3: an operating unit for the cable processing device in FIG. 1,

FIG. 4: a perspective representation of the cable processing device according to FIG. 1 with a closed protective hood,

FIG. 5: the cable processing device with an open protective hood, and

FIG. 6: an enlarged view of the cable processing device according to FIG. 1 in a perspective representation.

### DETAILED DESCRIPTION

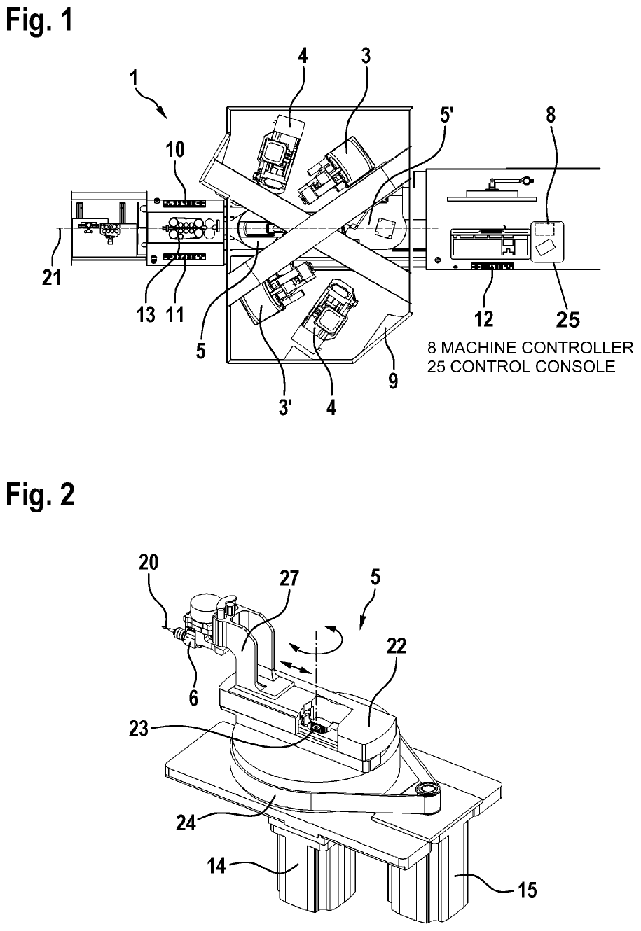

FIG. 1 shows a cable processing device, denoted as a whole by 1 and designed as a pivot machine, for assembling cables (not shown here). The cable processing device 1 comprises a cable conveyor 13 designed as a belt conveyor, which brings the cable 20 (FIG. 2) along the longitudinal machine axis 21 to the feed unit 5 designed as a pivot unit. The pivot unit 5 has a cable gripper (which is covered by a protective hood 9 and is therefore not shown here) for holding the cable (cf. FIG. 2: cable gripper 6). As can be seen in FIG. 6, a stripping station 2 for cutting to length and stripping the cables is arranged on the longitudinal machine axis 21. On the other hand, the further processing stations 3 and 4 are arranged next to the longitudinal machine axis 21. For feeding the cable ends to these processing stations, the pivot unit 5 must be rotated around a vertical axis. The processing station denoted by 3 is a sleeve station, and the processing station denoted by 4 is a crimping station. The processing stations 3 and 4 are assigned to the leading cable end; the processing stations 3′ and 4′ serve to assemble the trailing cable ends. The second feed unit denoted by 5′ and designed as a pivot unit is in the pivoted-out position in FIG. 1. Additionally or alternatively, equipping stations for equipping cable ends with plug housings would also be conceivable as processing stations.

Furthermore, the cable processing device 1 has a protective hood 9, which can be moved between a closed position and an open position and, in the closed position, covers the processing stations 2, 3, 4 and 3′, 4′ and the feed units 5, 5′ with the cable grippers. In the open position, a free space is created via which the processing stations 2, 3, 4 and 3′, 4′ and the feed units 5, 5′ are accessible for manual interactions for moving the cable grippers. The cable processing device 1 shown here is characterized by a novel design with regard to the setup, and the design is explained in detail below with reference to the crimping station 4. The operating unit denoted by 10 serves to carry out the setup process for the crimping station 4.

As can be seen from FIG. 1, the cable processing device 1 has further operating units 11 and 12. The stripping station 2 can be set up using the operating unit 11, which is arranged on a side of the cable processing device 1 opposite the operating unit 10 with respect to the machine longitudinal axis 21. If necessary, however, it can also be used for setting up the crimping station 4. The crimping station 4′ and, where applicable, the further processing stations assigned to the trailing cable end can be set up using the operating unit 12.

The crimping station 4 contains a crimping press for connecting a cable end to a crimp contact. The crimping station 4 with a crimping press, which is already known per se, has a tool holder, which can be driven and moved up and down in the vertical direction by means of a motor. A crimping tool is inserted between the tool holder and a console for the crimping press. The crimping tool contains an anvil and a crimping die for establishing the crimp connection. Such or comparable crimping presses and crimping tools are known per se to the person skilled in the art. With regard to the design and the mode of operation for crimping presses and crimping tools, reference is made by way of example to EP 1 341 269 A1.

For crimping, it is important that the cable end that is to be processed and is held by the cable gripper is positioned as precisely as possible at the crimping station or, more precisely, in the crimping press between the anvil and the crimping die. This positioning must be performed when the cable processing device is set up with the crimping station, usually after the crimping tool has been changed or for setting up a new item (new combination of cable and crimp contact). In the setup presented here, in other words, the point is to initially set the cable processing device 1 with the crimping station 4 before the start of the actual production process, in such a way that in normal operation for production, the cable gripper is moved into the correct position, from which position the cable end of the cable is equipped with a crimp contact in the crimping station 4.

The feed unit 5 is set up in such a way that, in a setup mode, the cable gripper 6 can be moved manually to the crimping station 4 into the desired position by a user. A machine controller 8 for controlling the cable processing device 1 is designed in such a way that, after the desired position has been established manually, this position or an associated control variable can be stored in the machine controller 8 after confirmation by the user. In a normal operating mode, the cable gripper 6 is automatically brought into this position in a manner controlled by the machine controller 8 and the cable end held by the cable gripper is crimped in the crimping station 4.

This setup process takes place when the protective hood 9 is open. The machine controller 8 is designed in such a way that, when the protective hood 9 is in the open position, the crimping station 4 and the feed unit 5 are deactivated and do not allow any processing process. In this way, accidents involving persons can be ruled out.

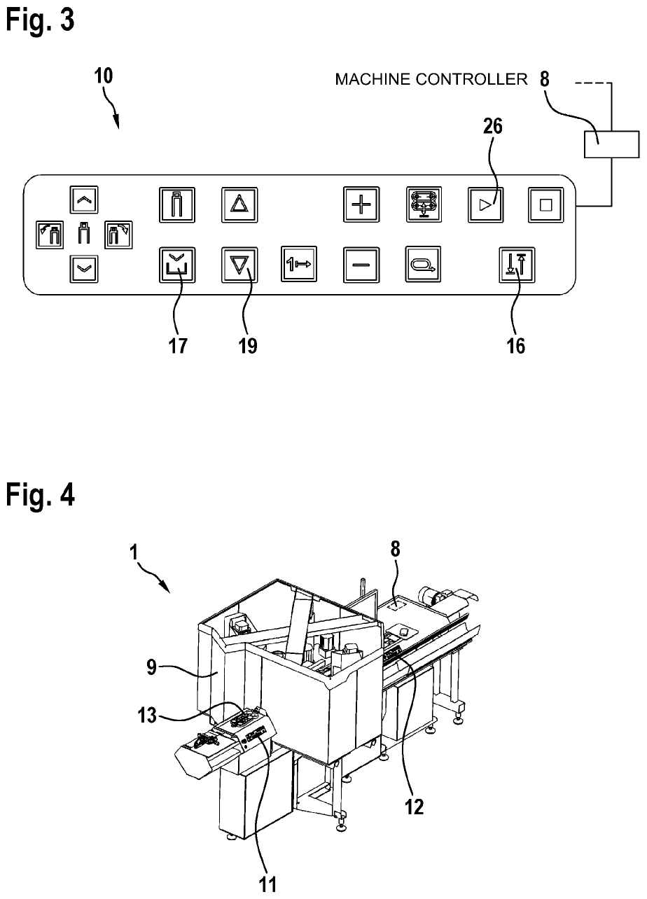

The feed unit 5 with the cable gripper 6 can be moved manually by pulling, pushing, pivoting and/or lowering the feed unit, wherein the cable processing device 1 is designed in such a way that the movements can be carried out with only one hand or one-handedly. After the desired position has been established manually, this position must be stored in the machine controller 8 after confirmation. A save button can be used to store the position. The operating unit 10 shown in FIG. 3 for the cable processing device 1 has such a save button, and the save button is denoted by 17 there.

It is most expedient if save buttons 17 are arranged at several locations on the machine and enable the operator to position and hold the cable gripper with one hand while pressing a save button 17 with the other hand. In the present case, each of the three operating units 10, 11, 12 has such a save button 17, which considerably facilitates handling with regard to the necessary different setup processes (see subsequent FIG. 3; the operating units 11 and 12 in this case have a design similar to the operating unit 10).

FIG. 2 shows a feed unit 5 for the cable processing device 1. For moving the cable gripper 6, the feed unit comprises servo or stepper motors 14 and 15 equipped with encoders. The encoders are connected to the machine controller 8 in such a way that, by means of the encoders, the position of the cable gripper 6 can be ascertained after the manual movement in the setup mode.

Since the operator sets the correct position of the cable end relative to the processing station in that the operator moves the cable gripper 6 by hand when the protective hood 9 is open, the machine controller 8 should be able to detect the position of the cable gripper 6 during this movement. The sensor system necessary for this purpose is already present, since it is also required for position regulation or position control when the pivot unit 5 is moved automatically in normal operation. Specifically, by way of example, the feed unit 5 can have a first motor 14, which moves a carriage 22 via the rack and pinion arrangement 23, which results in the radius of a polar coordinate for the cable gripper 6. The cable gripper 6 is arranged at a front end of a gripper arm 27, wherein the gripper arm 27 is attached to the carriage 22. A second motor 15 with a toothed belt 24 pivots a turntable and thus determines the angle of the polar coordinate for the cable gripper 6. Both motors 14 and 15 have encoders, from the angular positions of which the position of the cable gripper 6 can be calculated.

The manual movement for setting the correct position of the cable gripper 6 may also be realized on the basis of other movement mechanisms for the cable gripper, and other measuring systems may also be used for ascertaining the position, provided that the drives are advantageously not designed to be self-locking (such as in the case of threaded spindles). The concept described above can also be used for so-called transfer machines. These are another known type of cable processing devices. The so-called “transfer machines” or “linear machines” are cable processing machines in which the respective cable processing stations are arranged on a line along the main machine axis. Such a cable processing device of the transfer machine type has become known, for example, from EP 1 073 163 A1.

The critical actuators, which include at least the motors 14 and 15 for the movements of the pivot units 5 and 5′ with the cable grippers 6, the motors for the crimping press at the crimping stations 4 and 4′, and advantageously, the motors for the drive on the cutting head at the stripping station 2 and particularly advantageously, all the actuators for the cable processing device 1 are de-energized by the machine controller 8 when the protective hood is open (no torque on the motors). As a result, when the protective hood 9 is open, no movements with the pivoting arms, the cutting head and the crimping press can be carried out, not even at creep speed. If pneumatic movements classified as dangerous are present in the process modules, these actuators can likewise be switched off (no pressure on the switch valves).

FIG. 3 shows an operating unit 10, which has a number of further buttons besides the save button 17 for storing the position of the cable gripper reached after the manual movement. The operating unit 10 comprises a hood button 16 for operating the protective hood 9, by means of which the protective hood 9 can be opened and/or closed. The hood button 16 is connected to the machine controller 8 in such a way that, in the case of the hood button 16, the protective hood 9 is brought from the closed position into the open position, and the setup mode is established in the process. Appropriate drives (not shown here) are provided for moving the protective hood 9. Due to the higher hazard potential, an additional security feature is provided for closing the protective hood 9. In addition to the hood button 16, a further button 19 is provided, by means of which it can be confirmed that the protective hood 9 is to be brought from the open position into the closed position. The button 19 is therefore referred to below as a “close-hood button”. The hood button 16 and the close-hood button 19 are connected to the machine controller 8 and the machine controller 8 is configured such that the protective hood 9 can be brought from the open position into the closed position only if both buttons 16 and 19 are pressed simultaneously. For two-hand operation, the hood button 16 and the close-hood button 19 are spaced apart from one another by at least 27 cm, thereby preventing a hand of the user from remaining in the danger zone within the protective hood.

In the present exemplary embodiment, storing the position of the cable gripper during the setup is accomplished by means of save buttons 17 outside the protective hood 9. However, it is also conceivable to arrange such save buttons locally on the feed unit or at the processing stations. Instead of buttons, however, the cable or gripper position could also be stored using other means, for example via an operator interface for the machine controller, which may already be present anyway, (e.g., computer mouse, keyboard or touch function), using a sensor that detects the lowering of the cable gripper by hand, or acoustically via voice recognition.

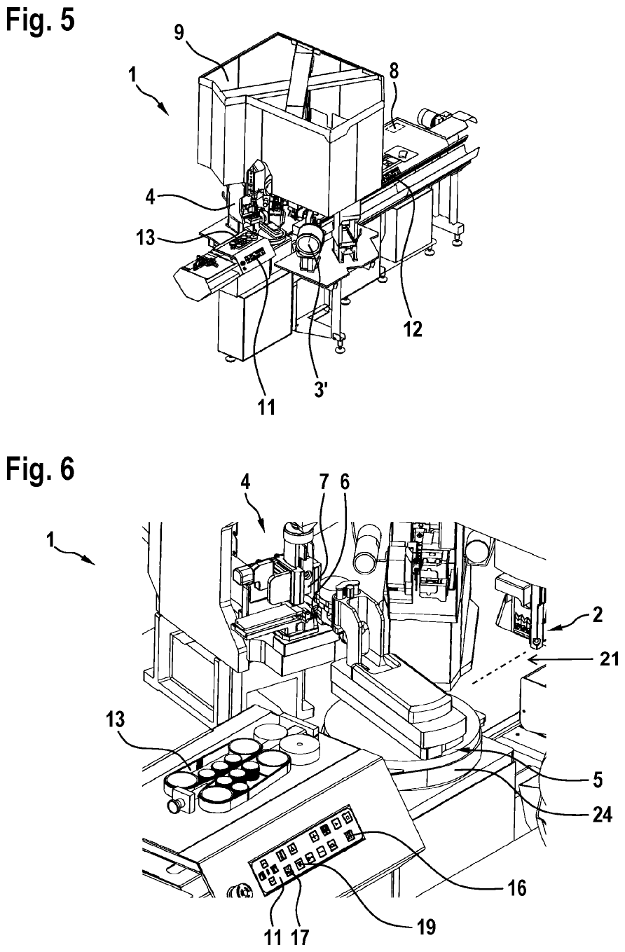

FIGS. 4 and 5 show the cable processing device 1 with the protective hood 9 in the closed position (FIG. 4) and with the protective hood 9 in the open position (FIG. 5). The method for setting up the cable processing device 1 proceeds with respect to the crimping station 4 as follows: The operator can indicate to the machine controller 8 that a cable is to be fed to the crimping station 4 with the crimping press 7 (FIG. 6). For this purpose, the operator presses, for example, a so-called cable call button, whereupon the cable is guided toward the crimping station 4. After activation of the feed process, the cable is cut to length and stripped if necessary. The feed unit 5 brings the cable end in front of the crimping press for the crimping station 4 and stops at a predefined or the last stored position. Now the actual setup process, which has already been at least partially described above, can begin. The operator uses the hood button 16 to open the protective hood 9, as a result of which the cable processing device 1 is put into the setup mode and the machine controller 8 de-energizes the electromotive actuators for the cable processing device 1 and/or depressurizes the pneumatic actuators for the cable processing device 1. Thereafter, the operator moves the feed unit 5 with the cable gripper 6 by hand until the cable end assumes the desired position relative to the crimping station or another processing station. If necessary, the operator can lower the cable gripper 6 by hand. During this manual positioning process, the machine controller 8 continuously calculates the polar coordinates of the gripper position, or of the position of the cable end, from the encoder data and, where applicable, represents the position of the cable gripper 6 on a screen or another display for the operating unit 10, 11, 12 or for the control console 25. In order to complete the positioning process, the operator presses the save button 17. Thereafter, the operator can close the protective hood 9 by pressing buttons. Thereafter, a crimping process or, depending on the processing station set up, also another processing process can be carried out for test purposes or normal manufacturing of assembled cables can even be started directly. Such a test run can, for example, be started automatically as soon as the protective hood 9 is closed, or the test run can be started by input means, such as a start button 26.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A cable processing device for assembling cables, the cable processing device comprising:
a plurality of processing stations;
a feed unit including a cable gripper adapted to feed a cable end of a cable to at least one of the processing stations;
a machine controller controlling the cable processing device;
wherein when the machine controller is in a setup mode, the cable gripper can be moved manually to the at least one processing station into a desired position; and
wherein the machine controller, after the desired position has been established manually, stores a position of the cable gripper in the machine controller.

2. The cable processing device according to claim 1 wherein the feed unit has at least one servo motor or stepper motor equipped with an encoder and adapted to move the cable gripper to the at least one processing station during a normal operating mode of the cable processing device, the encoder being connected to the machine controller such that the position of the cable gripper is ascertained by the machine controller from an output of the encoder after the manual movement in the setup mode.

3. The cable processing device according to claim 1 including a protective hood movable between a closed position and an open position and, in the closed position, the protective hood covers the at least one processing station and the feed unit and, in the open position, the protective hood creates a free space via which the at least one processing station and the feed unit are accessible for manual interactions for moving the cable gripper, wherein when the protective hood is in the open position, the machine controller deactivates the at least one processing station and the feed unit and does not allow any processing process or the machine controller de-energizes actuators for operating the at least one processing station and the feed unit.

4. The cable processing device according to claim 3 including an operating unit having a hood button adapted to operate the protective hood, wherein the hood button is connected to the machine controller such that the setup mode is automatically established during or after actuation of the hood button.

5. The cable processing device according to claim 4 wherein the operating unit has a further button connected to the machine controller and adapted to confirm that the protective hood is to be brought from an open position into a closed position.

6. The cable processing device according to claim 5 wherein machine controller brings the protective hood from the open position into the closed position only when the hood button and the further button are pressed simultaneously.

7. The cable processing device according to claim 1 including an operating unit having a save button adapted to cause the machine controller to store the position of the cable gripper after the manual movement.

8. The cable processing device according to claim 1 including a plurality of operating units each connected to the machine controller, wherein each of the operating units has a save button adapted to cause the machine controller to store the position of the cable gripper after the manual movement.

9. The cable processing device according to claim 8 wherein each of the processing stations is assigned to one of two groups, wherein a first of the groups processes a leading end of the cable and a second of the groups processes a trailing end of the cable, wherein at least one operating units is assigned to each of the two groups.

10. The cable processing device according to claim 1 wherein the at least one processing station is a crimping station to which the cable gripper can be moved manually in the setup mode.

11. A method for setting up a cable processing device for assembling cables, the cable processing device including at least one processing station and a feed unit, the feed unit including a cable gripper for feeding a cable end of a cable to the at least one processing station, the method comprising the steps of:
putting the cable processing device into a setup mode;
manually moving the feed unit with the cable gripper until the cable gripper reaches a desired position in the at least one processing station; and
storing a position of the cable gripper when the cable gripper reaches the desired position, and using the stored position for controlling the feed unit during a normal operating mode of the cable processing device.

12. The method according to claim 11 wherein, after the position of the cable gripper has been stored, carrying out a single processing process for test purposes, and visually checking a processed cable end of the cable when the feed unit with the cable gripper is moved toward a user.

13. The method according to claim 11 including putting the cable processing device into the setup mode when a protective hood covering the at least one processing station and the feed unit with the cable gripper is opened.
